(19) United States
(12) Patent Application Publication
(10) Pub. No.: US 2011/0311077 A1
(43) Pub. Date: Dec. 22, 2011

(54) Personalizable Alarm Siren

(76) Inventors: Victor Hugo Quiroga Cordoba, Lima (PE); Victor Hugo Quiroga Aguirre, Lima (PE); Carlos Enrique Quiroga Cordova, Lima (PE)

(21) Appl. No.: 13/000,204

(22) PCT Filed: Jun. 19, 2009
(86) PCT No.: PCT/IB2009/006202

§ 371 Date: Mar. 23, 2011

(30) Foreign Application Priority Data
Jun. 20, 2008 (PE) 001055-2008/OIN

(51) Int. Cl. H04R 25/00

(52) U.S. Cl. 381/150

(57) ABSTRACT

This device enables the user to personalize the sound that comes out of his/her siren, since this invention is an improvement over conventional sirens in that it has a 3.5 mm female jack for an audio input, a male connector for a pushbutton, a female connector joined to the pushbutton and said pushbutton, in addition to a recording/playback unit, a repetition control unit and an amplification unit incorporated with which the user can record an unlimited number of 30-second audios, whether from a microphone or a PC, and can play them back repeatedly to serve as an alarm.

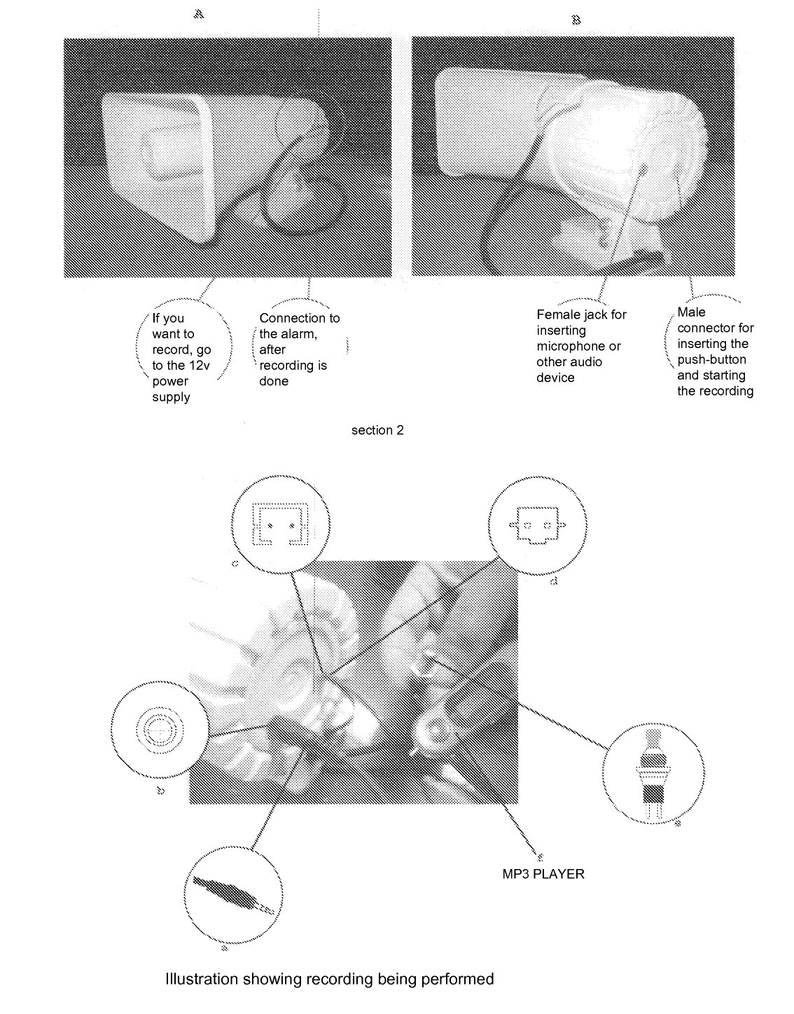

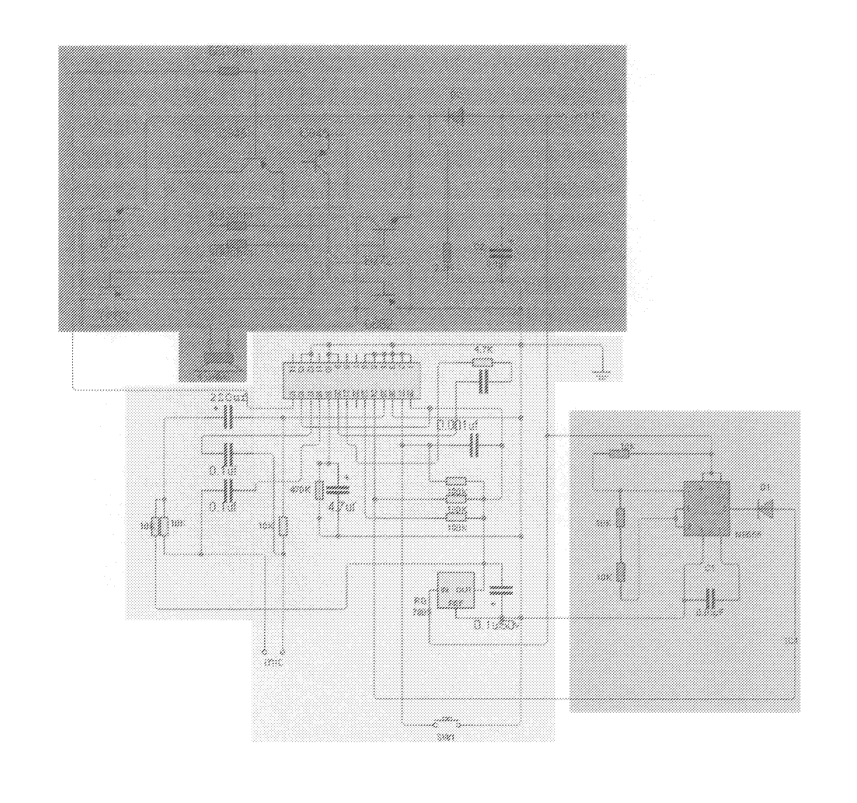

The present invention refers to modernization in the electronic field, implementing an improvement in the conventional siren by using a system of personalization of sounds incorporated into the same siren, improving the functionality of a conventional siren via the input of any audio-generating device (microphone—MP3—PC, etc.)

### PRIOR ART

This invention has as precedent a Speaker or Alarm Siren with sounds preestablished at the factory, without the end user's having any option to change them.

In this way a conventional speaker or alarm siren presents the following problem:
Standardization and difficult recognition of its sound, since it is hard for the user to determine if the alarm siren that sounds in public is his own, for example car alarms, all have the same sound. (They are manufactured standardized, that is, manufactured in series.)

As a consequence of this standardization, a certain indifference is produced among the community and forces of public order upon hearing the classic sound that at present is generated in alarm sirens, nullifying their reason for being, which is to alert those responsible, contributing to the fact that miscreants carry out their felonies without fear of discovery, since we have become accustomed to hearing them and thinking that an alarm sounding does not necessarily indicate an attempted robbery.

### Example: 1

At a reunion of heads of families of High School X, the parents attend with their cars, and approximately 90% of them have an antitheft alarm installed.

When a robbery is attempted and the siren “sounds,” it will “alert” 90% of heads of families, since the sound of a siren is standard and all of them will think it is their car that is being broken into, thus producing a daily problem in different areas of the city.

### DESCRIPTION OF INVENTION

With this device, the user will have the opportunity of personalizing the sound emitted by his/her siren, since the author of the present invention implemented a new siren with an incorporated record/playback, able to reproduce audio recorded by the user, whether from a microphone or a personal computer, and reproduce it repeatedly as an alarm.
A recording/voice reproduction device was added to the conventional alarm siren, with the novel attribute: personalization.

It consists of a siren (page 7-A), female jack for the audio input (for this occasion the 3.5 mm mono-stereo female jack, also called minijack, was chosen) (page 7-b), a male connector (page 7-B), female connector (page 7-section 2-d), connected to the pushbutton via a twin cable, a pushbutton which, when kept “on,” allows recording to proceed.

The electronic equipment consists of 3 fundamental units (page 8)

a) Record/playback Unit

b) Repetition Control Unit

c) Amplification Unit

a) Record/playback Unit

It stores the recording and plays it back afterward when powered with 12 v. (alarm voltage output) (page 8—shown in pink).

Components:

| ISD1420 Re-recordable integrated circuit and player | |
|---|---|
| LM7805 Voltage regulator | |
| 9¼ w. Resistors: | |
| (4) 10 k Resistors | |
| (1) 470 k Resistor | |
| (1) 4.7 k Resistor | |
| (3) 100 k Resistors | |
| (3) Non-polar capacitors (104) | 0.1 uF |
| (1) Non-polar capacitor (102) | 0.001 uF |
| (1) Electrolytic capacitor | 0.47 uF × 16 v |
| (1) Electrolytic capacitor | 100 uF × 16 v |
| (1) Electrolytic capacitor | 220 uF × 16 v |

b) Repetition Control Unit

This keeps constant the playback of the recording (page 8 - in sky blue)

Components:

| LM555 Integrated circuit (timer) | |
|---|---|
| (3) 10 k resistors | |
| 1 IN4148 diode | |
| Non-polar capacitor (104) | 0.1 uF |

c) Amplification Unit

This is designed for final amplification of the recording so that it can be emitted by the speaker (page 8, shown in green)

Components:
2 B772 NPN transistors
2 D882 PNP transistors
2 C945 PNP transistors
(2) ¼ watt 100 ohm Resistors
(1) 2.2 k Resistor
(1) IN4004 Diode
(1) 10 uf×16 v electrolytic capacitor
(1) 30 watt speaker

The system voltage is 12v.

Functioning

Let us suppose that one wishes to record on the siren in order to use it in a car alarm, a woman's voice exclaiming the following:

“This car is being robbed, call the police! This car belongs to Juan Guerra, call 4551767, tell the police!!”, etc., etc.

At first the record/playback unit must be powered by a 12-volt DC power supply so that it can fulfill the record/playback function.

Next, the pushbutton is inserted into the connector that is in the rear part of the siren, then the audio-generating source is connected (this can be an MP3 player, a microphone, a PC, etc.). In this case we are going to insert the MP3 player, with the audio file of a woman shouting, into the rear part of the siren's housing (page 7—section 2-f).

Connecting the MP3 player automatically gives access to the recording function (leaving the play function not activated). Now we can use the pushbutton, putting it into the “on” position, to start the recording, keep the pushbutton recording while the signal is being emitted, and afterward releasing the pushbutton to stop.

When the microphone is automatically disconnected, the recording function stops, giving way to the play function, which returns to its initial state, waiting to be powered and together with the amplification unit, repeatedly play the recording.

In this way the siren has been personalized as the owner wishes, when it is powered by 12 volts, or with the touch of an alarm, it will play the recording.

Technical Details:

Because the record/playback unit (page 8, shown in pink) contains the ISD 1420 integrated circuit, which operates at 5 volts of power, it must have a voltage regulator, which in this case is provided by the LM 7805.

It is equipped with a circuit that operates at 12v, the principal component of which is the 555 timer and is important for playing the recording constantly and repeatedly, since the record/playback circuit needs a negative voltage on pin 3 in order to maintain the playing loop and play until the alarm is inactivated.

It also includes among its components a transistor-based amplifier, and through this circuit the recording can be powerfully reproduced.

The output of pin 15 of the integrated circuit (ISD1420) is preamplified, first passing through a resistance of 680 ohms, and then to a transistor (C945) that acts as a preamplifier, so as to then supply the preamplified signal to the transistors (PNP and NPN) (D772 B882) to be amplified to 30 watts or more, according to the manufacturer's criteria.

Brief Description of the Attached Graphics:

Page 7 Section 1

A. Appearance of the siren

B. Rear part

Page 7 Section 2

a) Male mono-stereo 3.5 mm jack

b) Female mono-stereo 3.5 mm jack

c) A male connector for the pushbutton located in the rear part of the siren.

d) A female connector connected to the pushbutton by means of a twin cable.

e) Pushbutton

f) MP3 player

Page 8 Section 3

Electronic map indicated by colors:

Sky blue: Repetition control unit

Green: Amplification unit

Pink: Record/playback unit

1. Device for recording and repeatedly playing back amplified, personalized audio that comprises a speaker of 30 watts or more power, a record/playback circuit characterized in that it stores and plays back the audio signals, a circuit of negative voltage pulses characterized in that it maintains the recording in constant repetition, a voltage regulator circuit characterized in that it reduces the voltage from 12v to 5v that is utilized by the record/playback circuit, a connector for the pushbutton that activates the recording function, a mono-stereo audio input connector through which the audio signal enters (whether it be microphone, MP3, iPod or any audio-generating source).
